(19) United States
(12) Patent Application Publication
(10) Pub. No.: US 2014/0072687 A1
(43) Pub. Date: Mar. 13, 2014

(54) Apparatus and Methods for Separating an Egg Yolk from a Whole Egg

(71) Applicants: Annelouise Hemingway, Jefferson, GA (US); Mark Schwieg, Jefferson, GA (US)

(72) Inventors: Annelouise Hemingway, Jefferson, GA (US); Mark Schwieg, Jefferson, GA (US)

(21) Appl. No.: 13/865,112

(22) Filed: Apr. 17, 2013

Related U.S. Application Data
(60) Provisional application No. 61/698,028, filed on Sep. 7, 2012.
(60) Provisional application No. 61/753,502, filed on Jan. 17, 2013.

(51) Int. Cl. A47J 43/14

(52) U.S. Cl. CPC A47J 43/14
USPC 426/490; 99/497

(57) ABSTRACT

Disclosed are apparatus and methods for separating an egg yolk from a whole egg. Embodiments of the disclosure are described as having a vacuum-producing means coupled to a hollow cavity portion which has a yolk-entry aperture. After placing the yolk-entry aperture against a portion of the egg yolk, the vacuum-producing means may be operated to draw the egg yolk through the yolk-entry aperture thereby creating a shearing force between egg yolk and egg white that is effective for separating yolk from white. The separated yolk may be retained in the apparatus until expelled. Other described embodiments incorporate a yolk-retention aperture that is effective for both separating egg yolk from egg white and also retaining the separated egg yolk in the apparatus until expelled.

### CROSS REFERENCE TO RELATED APPLICATIONS

This non-provisional utility application claims the benefit of prior filed provisional application No. 61/753,502 filed Jan. 17, 2013. Application No. 61/753,502 is incorporated herein by reference. This non-provisional utility application claims the benefit of prior filed provisional application No. 61/698,028 filed Sep. 7, 2012. Application No. 61/698,028 is incorporated herein by reference.

### STATEMENT REGARDING FEDERALLY SPONSORED RESEARCH OR DEVELOPMENT

Not Applicable.

### DESCRIPTION OF ATTACHED APPENDIX

Not Applicable.

### BACKGROUND

The egg is a ubiquitous nutritious ingredient that finds a multitude of uses in a widely varying array of cooking styles and cuisines from around the world. Once the egg shell is cracked, the whole egg, comprising both egg yolk and egg white, may be removed. Often, the constituent parts of the egg, namely the egg yolk and the egg white, are required individually in a food preparation. Thus separating a whole egg into two parts, namely the egg yolk and the egg white, is commonly a necessary part of food preparation. Learning how to separate a whole egg into egg yolk and egg white using traditional methods is a skill that must be learned and may not be perfected by everyone. Accordingly, there is a need for apparatus and methods that improve the process of separating an egg yolk from a whole egg.

### SUMMARY

The present disclosure describes several embodiments of an apparatus for separating an egg yolk from a whole egg. In the first embodiment the apparatus is described as comprising: a vacuum-producing means configured to produce a plurality of pressure levels comprising at least a first pressure level lower than the local ambient atmospheric pressure when operated, and comprising at least a second pressure level higher than the local ambient atmospheric pressure when operated; a hollow cavity portion operatively coupled to said vacuum-producing means, the hollow cavity portion having: a cavity volume at least large enough to hold one egg yolk; a yolk-entry aperture configured for drawing said egg yolk from outside of the apparatus into said hollow cavity when the vacuum-producing means is operated at said first pressure level.

A number a variations upon the embodiments are described such as: an apparatus in which the yolk-entry aperture is further characterized as having a yolk-entry aperture cross-sectional area of at least about 0.20 square inches; an apparatus in which the yolk-entry aperture is further characterized as having a yolk-entry aperture cross-sectional area of at most about 1.23 square inches; an apparatus in which the yolk-entry aperture cross-sectional area is approximately circular in shape; an apparatus in which the vacuum-producing means is manually operable; an apparatus being further characterized in that the hollow cavity portion has a cavity cross-sectional area and in that the yolk-entry aperture has a yolk-entry aperture cross-sectional area, and in that the cavity cross-sectional area and the yolk-entry aperture cross-sectional area are not equal in area; and, an apparatus in which the yolk-entry aperture cross-sectional area is smaller than the cavity cross-sectional area.

The present disclosure describes another embodiment of an apparatus for separating an egg yolk from a whole egg comprising: a vacuum-producing means configured to produce a plurality of pressure levels comprising at least a first pressure level lower than the local ambient atmospheric pressure at least a second pressure level higher than the local ambient atmospheric pressure when operated; a first hollow cavity portion operatively coupled to said vacuum-producing means, the first hollow cavity portion having: a first cavity volume at least large enough to hold one egg yolk; a first hollow cavity cross-sectional area; and, a yolk-retention aperture having a yolk-retention aperture cross-sectional area that is smaller than the first hollow cavity cross-sectional area; a second hollow cavity portion operatively coupled to the yolk-retention aperture, the second hollow cavity portion having: a second cavity volume coupled to a yolk-entry aperture, the yolk-entry aperture configured for drawing the egg yolk from outside the apparatus through the second hollow cavity portion when said vacuum-producing means is operated at the first pressure level.

The present disclosure describes additional features of the embodiments such as: apparatus in which the yolk-entry aperture is further characterized as having a yolk-entry aperture cross-sectional area of at least about 0.20 square inches; apparatus in which the yolk-entry aperture is further characterized as having a yolk-entry aperture cross-sectional area of at most about 1.23 square inches; apparatus in which the yolk-entry aperture has a cross-sectional area that is approximately circular in shape; apparatus in which the vacuum-producing means is manually operable; apparatus in which the yolk-retention aperture has a yolk-retention aperture cross-sectional area that is approximately circular in shape; apparatus further characterized in that the first hollow cavity portion has a first cavity cross-sectional area and in that the yolk-retention aperture has an yolk-retention aperture cross-sectional area, and that the first cavity cross-sectional area and the yolk-retention aperture cross-sectional area are not equal in size; and, apparatus in which the yolk-retention aperture cross-sectional area is substantially equal to the first hollow cavity cross-sectional area.

Further embodiments of the present disclosure describe an apparatus further characterized in that the hollow cavity portion may have a cavity sidewall length of at least about 0.12 inches in length. Further embodiments of the present disclosure describe an apparatus further characterized in that the hollow cavity portion may have a cavity sidewall length of at most about 0.75 inches in length. Further embodiments of the present disclosure describe an apparatus further characterized in that the hollow cavity portion may have a cavity sidewall length of at least about 0.12 inches in length and at most about 0.75 inches in length.

In addition the present disclosure describes a method of separating an egg yolk from a whole egg, the method comprising the steps of: placing a yolk-entry aperture in contact with at least a portion of the egg yolk; drawing said egg yolk through said yolk-entry aperture into a hollow cavity portion by the operation of a vacuum-producing means; and, creating a shearing force between the egg yolk and the egg white by drawing said egg yolk through said hollow cavity portion. Variations to the method are further described as additionally comprising the steps of: drawing the egg yolk through a yolk-retention aperture by the operation of the vacuum-producing means; holding the egg yolk proximate to the yolk-retention aperture; configuring the yolk-entry aperture to have a yolk-entry aperture cross-sectional area more than about 0.20 square inches; and, configuring the yolk-entry aperture to have a yolk-entry aperture cross-sectional area less than about 1.23 square inches.

### BRIEF DESCRIPTION OF THE DRAWINGS

These and other features, aspects, and advantages of the present invention will become better understood with regard to the following description, appended claims, and accompanying drawings where:

FIG. 1A shows a perspective view of an embodiment of an apparatus for separating an egg yolk from a whole egg according to the present disclosure. The figure shows the apparatus prior to using it to separate an egg yolk from the whole egg shown. Section views 2A and 2B are indicated.

FIG. 1B shows a perspective view of the embodiment of the apparatus of FIG. 1A after the apparatus has been used to separate the egg yolk from the whole egg shown in FIG. 1A.

FIG. 2A shows a longitudinal cross-sectional view of the apparatus of FIG. 1A.

FIG. 2B shows a cross-sectional view of the apparatus of FIG. 1A detailing the yolk-entry aperture of that embodiment.

FIG. 3A shows a cross-sectional view of another embodiment of an egg-separating apparatus according to the present disclosure. Section views 3B and 3C are indicated.

FIGS. 3B and 3C show sectional views of the apparatus of FIG. 3A.

FIG. 4A shows a perspective view of another embodiment of an egg separator according to the present disclosure. The figure shows the apparatus prior to using it to separate an egg yolk from the whole egg show. Section views 5A and 5B are indicated.

FIG. 4B shows perspective view of the embodiment of the apparatus of FIG. 5A after the apparatus has been used to separate the egg yolk from the whole egg shown in FIG. 5A.

FIG. 5A shows a longitudinal cross-sectional view of the apparatus of FIG. 4A.

FIG. 5B shows a cross-sectional view of the apparatus of FIG. 4A detailing the yolk-retention aperture of that embodiment.

FIG. 5C shows a cross-sectional view of the apparatus of FIG. 4A detailing the yolk-entry aperture of that embodiment.

### LIST OF REFERENCE NUMBERS APPEARING IN THE FIGURES

2—apparatus for separating an egg yolk from a whole egg

4—egg yolk

5—egg white

6—whole egg

10—vacuum-producing means

20—hollow cavity portion

20a—first hollow cavity portion

20b—second hollow cavity portion

22—cavity volume

22a—first cavity volume

22b—second cavity volume

24—cavity cross-sectional diameter

24a—first cavity cross-sectional diameter

24b—second cavity cross-sectional diameter

26—cavity cross-sectional area

26a—first cavity cross-sectional area

26b—second cavity cross-sectional area

28—cavity sidewall length

28a—first cavity sidewall length

28b—second cavity sidewall length

30—yolk-entry aperture

32—yolk-entry aperture cross-sectional diameter

34—yolk-entry aperture cross-sectional area

40—yolk-retention aperture

42—yolk-retention aperture cross-sectional diameter

44—yolk-retention aperture cross-sectional area

### DESCRIPTION

The present invention is now described with reference to the drawings, wherein like reference numerals are used to refer to like elements throughout. In the following description, for purposes of explanation, numerous specific details are set forth in order to provide a thorough understanding of the present invention. It may be evident, however, that the present invention can be practiced without these specific details.

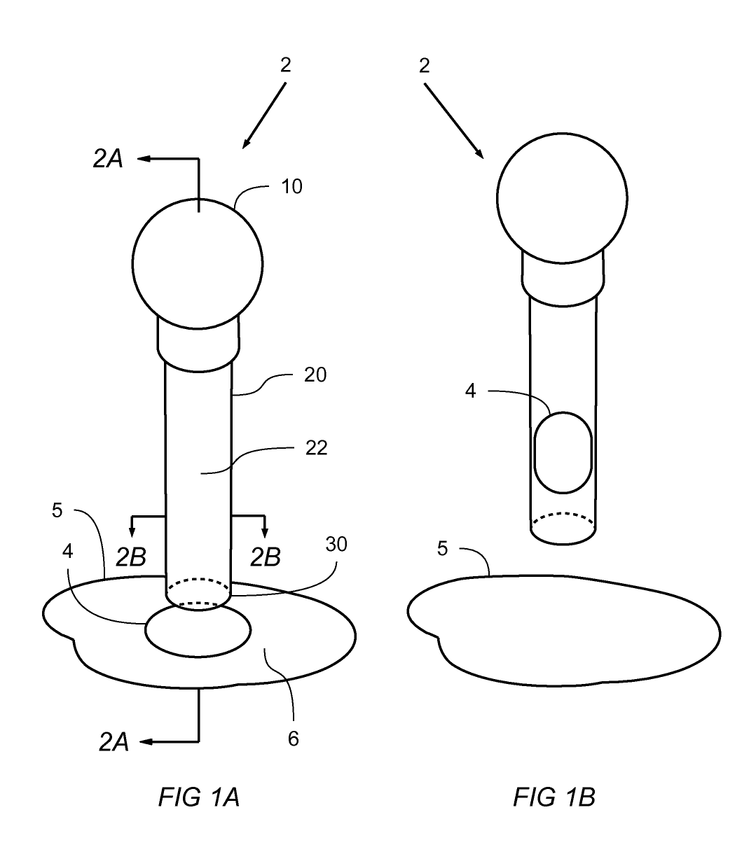

Turning now to FIG. 1A, shown is an isometric view of an apparatus for separating an egg yolk from a whole egg 2 according to an embodiment of the present disclosure. For the purposes of this disclosure a whole egg 6 is understood to comprise an egg yolk 4 and an egg white 5. The apparatus of FIG. 1A shows apparatus for separating an egg yolk from a whole egg 2 comprising: a vacuum-producing means 10 operatively coupled to a hollow cavity portion 20 having a cavity volume 22, which is at least large enough to hold one egg yolk, said hollow cavity portion having a yolk-entry aperture 30 configured for drawing egg yolk 4 from outside of the apparatus into said hollow cavity portion 20 when the vacuum-producing means is operated. The apparatus of FIG. 1A is operable to separate egg yolk 4 from a substantial portion of egg white 5.

vacuum-producing means 10 is operable to produce a plurality of pressure levels in which at least a first pressure level is lower than the ambient atmospheric pressure and at least a second pressure level is above the ambient atmospheric pressure. vacuum-producing means 10 may be constructed of a rubber, silicone rubber, or other elastomeric material suitable for food service duty and may be configured such that it may be operated by hand to produce the said plurality of pressure levels. Furthermore, the vacuum-producing means may have a different form or shape from the shape shown in the figures. For example, a plunger or piston configuration may be used as the vacuum-producing means, or an accordion-styled squeeze bulb may be used as an alternative. In preferred embodiments the vacuum-producing means 10 is manually operable, but in other embodiments it may be operated via mechanical, electro-mechanical, pneumatic or other means commonly used in a high volume production environment. In addition, vacuum-producing means 10 may be designed to be detachable from hollow cavity portion 20 in order to facilitate cleaning and manufacture of the egg separator. In other embodiments the vacuum-producing means and the hollow cavity portion may be rigidly attached together. In still other embodiments the vacuum-producing means may share the function of the hollow cavity portion and are one and the same component.

Hollow cavity portion 20 may be constructed of a material compatible with food service operation and may be configured to be rigid enough to substantially retain the shape of yolk-entry aperture 30 when vacuum-producing means 10 is operated. Embodiments of the apparatus may use a transparent or translucent material for hollow cavity portion 20 so that the operator may see egg yolk 4 when it is retained in hollow cavity portion 20.

In the embodiment shown in FIG. 1A and FIG. 1B vacuum-producing means 10 may be uncoupled from hollow cavity portion 20 to facilitate cleaning of the apparatus, which is always a critical issue with regard to food safety concerns. After cleaning, the components may be recoupled to form the apparatus of FIGS. 1A and 1B again and the apparatus may be used as before. Furthermore, in other embodiments, vacuum-producing means 10 and hollow cavity portion 20 may be integrated into a single component.

After removing the egg from its shell and placing the whole egg in a suitable receptacle, operation of the apparatus of FIG. 1A may proceed as follows: vacuum-producing means 10 may be operated to expel a portion of air from the apparatus; yolk-entry aperture 30 may be placed in contact or near contact with at least a portion of egg yolk 4 thereby creating an air-tight seal at or near the surface of the egg yolk; vacuum-producing means 10 may then be operated to create a pressure within the apparatus that is lower than the ambient atmospheric pressure; the pressure difference then gives rise to forces urging egg yolk 4 through yolk-entry aperture 30, the movement of the egg yolk through the yolk-entry aperture in turn creating a shearing force between egg yolk 4 and egg white 5 urging the two to separate; and, further movement of the egg yolk inside hollow cavity portion 20 creating additional shearing force between egg yolk 4 and egg white 5 further urging the two to separate.

FIG. 1B shows the apparatus of FIG. 1A after having been operated to separate egg yolk 4 from the whole egg 6 of FIG. 1A. FIG. 1B accordingly shows that, as a result of operating the apparatus, egg yolk 4 may be retained in hollow cavity portion 20 while leaving at least a portion of egg white 5 behind. Once egg yolk 4 is retained in hollow cavity portion 20 the apparatus may be moved as needed, after which vacuum-producing means 10 may be operated to produce a second pressure level that is above the ambient atmospheric pressure and thereby expel the retained egg yolk from the apparatus according to the operator's intention.

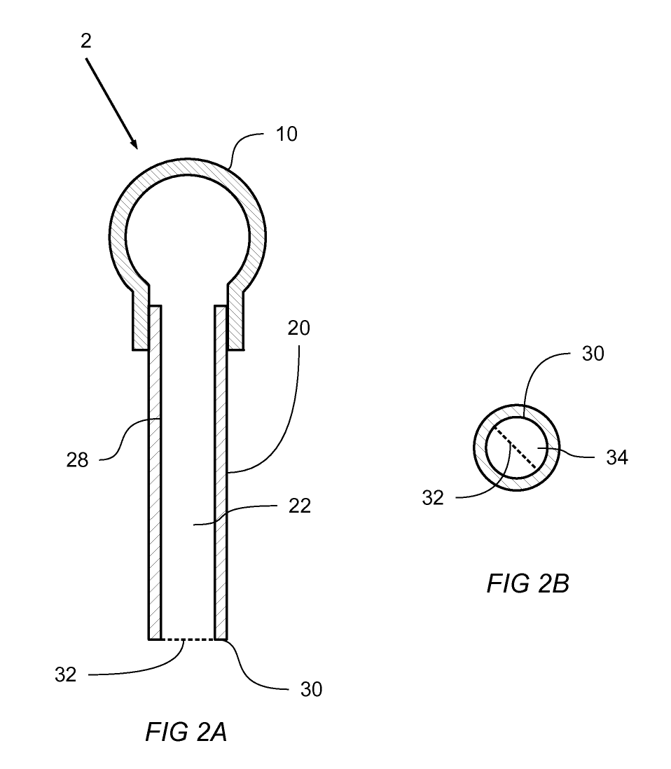

FIG. 2A is a cross-sectional view of the apparatus of FIG. 1A and FIG. 1B. FIG. 2A shows vacuum-producing means 10 coupled to hollow cavity portion 20 having a cavity volume 22 and cavity sidewall length 28, the hollow cavity portion also having yolk-entry aperture 30 configured to have a yolk-entry aperture cross-sectional diameter 32 suitable for drawing an egg yolk through. FIG. 2B is a cross-sectional view of the apparatus of FIG. 1A and FIG. 1B showing details of yolk-entry aperture 30. In FIG. 2B yolk-entry aperture 30 is characterized as having yolk-entry aperture cross-sectional diameter 32 and yolk-entry aperture cross-sectional area 34.

The inventors have discovered that the size and shape of yolk-entry aperture 30 are important factors in the optimal performance of the apparatus in the egg separation task. Eggs sold for general consumption typically fall within four descriptive categories of medium, large, extra-large, and jumbo based on the size of the egg. A user of the apparatus would expect the device to handle medium through jumbo egg yolks. Experimentation of various yolk-entry aperture configurations has shown that the preferred aperture cross-sectional area 34 for these apertures should fall within the range of about 0.20 sq. inch to about 1.23 sq. inch for the apparatus to function optimally. In addition, circular to ellipsoidal shaped yolk-entry aperture cross-sectional areas are preferred. Configurations with these preferred general shapes tend to minimize frictional and deformational forces as the yolk is drawn into the apparatus, as these shapes mimic the natural cross-sectional shape of an egg yolk. The yolk-entry aperture may further have a fluted, tapered, or rounded end to aid in creating an airtight seal at the yolk surface.

Hollow cavity portion 20 where egg yolk 4 is held is preferably sized to have a cavity volume 22 large enough to accommodate at least a single egg yolk, but in some configurations it may be sized sufficiently larger with a cavity volume able to receive and hold multiple egg yolks. Hollow cavity portion 20 is preferably a cylindrical tube with parallel side walls, but in other configurations may have tapered side walls. Further, it should be understood that in various embodiments of the invention the hollow cavity portion may be any shape or size and have a hollow cavity cross-sectional diameter that is greater than, less than, or equal to the cross-sectional diameter of the yolk-entry aperture.

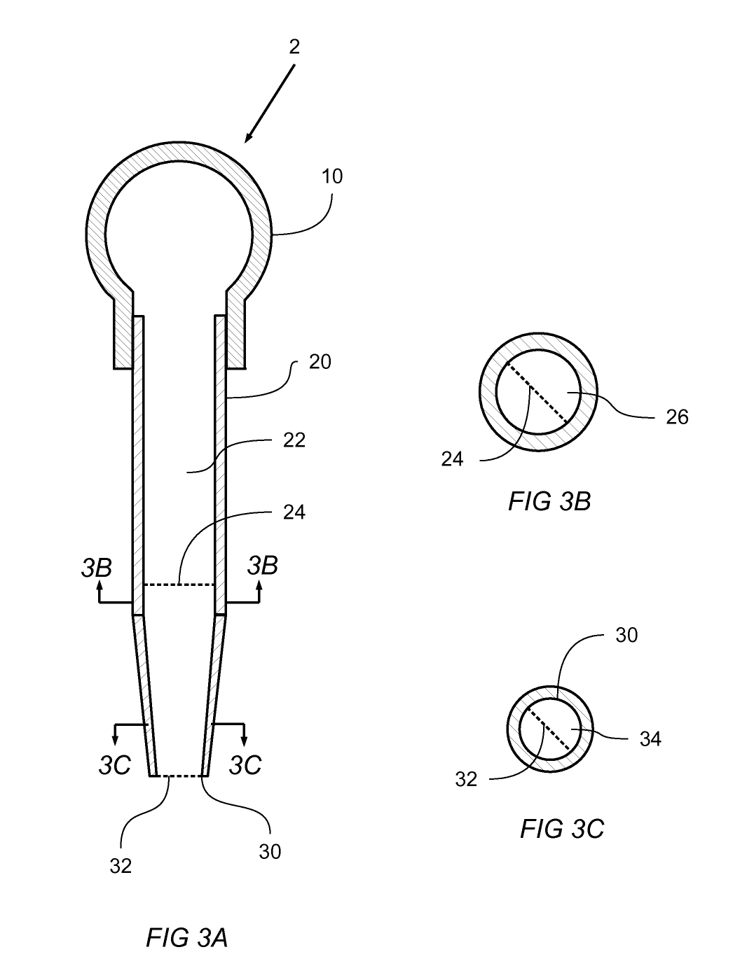

Turning now to FIG. 3A, shown is a cross-sectional view of an apparatus for separating an egg yolk from a whole egg 2 according to another embodiment of the present disclosure. The apparatus of FIG. 3A shows apparatus for separating an egg yolk from a whole egg 2 comprising: a vacuum-producing means 10 operatively coupled to a hollow cavity portion 20 having: a cavity volume 22 which is at least large enough to hold one egg yolk; a cavity cross-sectional diameter 24; and a yolk-entry aperture 30 having a yolk-entry aperture cross-sectional diameter 32, and in which yolk-entry aperture 30 is configured for drawing an egg yolk from outside of the apparatus into said hollow cavity portion 20 when the vacuum-producing means is operated. The apparatus of FIG. 3A is operable to separate an egg yolk from a substantial portion of egg white. FIG. 3B is a cross-sectional view of the apparatus of FIG. 3A in which hollow cavity portion 20 is characterized as having cavity cross-sectional diameter 24 and cavity cross-sectional area 26. FIG. 3C is a cross-sectional view of the apparatus of FIG. 3A in which yolk-entry aperture 30 of hollow cavity portion 20 is characterized as having yolk-entry aperture cross-sectional diameter 32 and yolk-entry aperture cross-sectional area 34. As depicted in FIGS. 3B and 3C, in some embodiments cavity cross-sectional area 26 may be larger than yolk-entry aperture cross-sectional area 32. In other embodiments, cavity cross-sectional area 26 and yolk-entry aperture cross-sectional area 32 may not be equal in area.

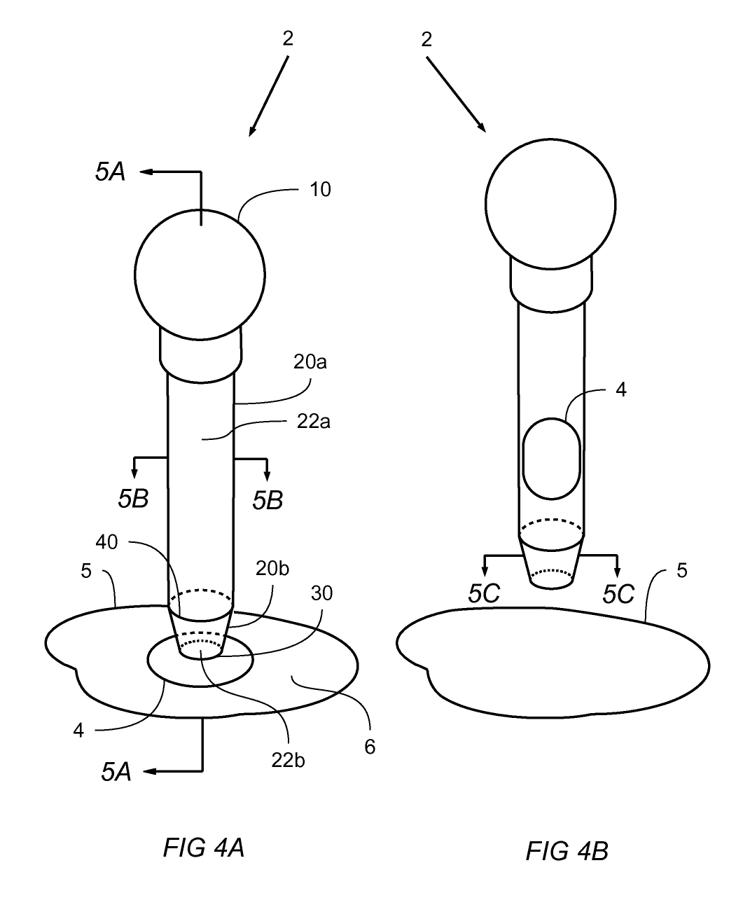

Turning now to FIG. 4A, shown is an isometric view of an apparatus for separating an egg yolk from a whole egg 2 according to another embodiment of the present disclosure. The apparatus of FIG. 4A shows apparatus for separating an egg yolk from a whole egg 2 comprising: vacuum-producing means 10 configured to produce a plurality of pressure levels comprising at least a first pressure level lower than the local ambient atmospheric pressure and at least a second pressure level higher than the local ambient atmospheric pressure when operated; a first hollow cavity portion 20a operatively coupled to said vacuum-producing means 10, the first hollow cavity portion 20a having: a first cavity volume 22a at least large enough to hold one egg yolk and a yolk-retention aperture 40; a second hollow cavity portion 20b having a second cavity volume 22b is operatively coupled to said first hollow cavity portion 20a; second hollow cavity portion 20b being further characterized as having a yolk-entry aperture 30 configured for drawing said egg yolk 4 from outside the apparatus through second hollow cavity portion 20b and into first hollow cavity 20a when said vacuum-producing means 10 is operated at said first pressure level. As shown in FIG. 4B, the apparatus of FIG. 4A is operable to separate egg yolk 4 from whole egg 6 thereby leaving a substantial portion of egg white 5 behind.

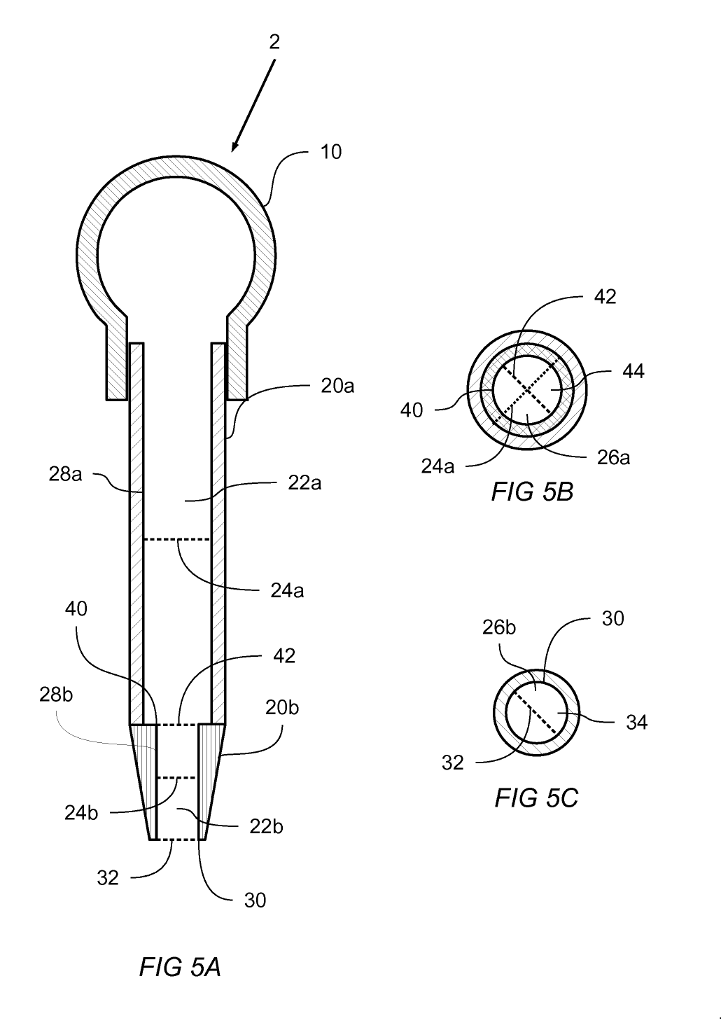

Turning now to FIG. 5A, 5B, and 5C, shown are cross-sectional views previously indicated in both FIG. 4A and FIG. 4B. FIG. 5A shows further features of the apparatus of FIG. 4A in which first hollow cavity portion 20a has a first cavity sidewall length 28a and a first cavity volume 22a and is further characterized as having first cavity cross-sectional diameter 24a, and, yolk-retention aperture 40 is further characterized as having a yolk-retention aperture cross-sectional diameter 42 which is smaller than first cavity cross-sectional diameter 24a, and second hollow cavity portion 20b is further characterized as having a second cavity cross-sectional diameter 24b and a second cavity sidewall length 28b. Yolk-retention aperture 40 is effective for retaining the egg yolk once it has been drawn in to first hollow cavity 20a.

FIG. 5B shows a cross-sectional view of the apparatus of FIG. 4A detailing the yolk-retention aperture of that embodiment. FIG. 5B further shows that first hollow cavity portion 20a is characterized as having: first cavity cross-sectional diameter 24a; first cavity cross-sectional area 26a; yolk-retention aperture 40; a yolk-retention aperture cross-sectional diameter 42; and, a yolk-retention aperture cross-sectional area 44. As shown in FIGS. 5A and 5B it is preferred that yolk-retention aperture cross-sectional diameter 42 is smaller than first hollow cavity cross-sectional diameter 24a. FIG. 5C is a cross-sectional view of the apparatus as indicated on FIG. 4B in which yolk-entry aperture 30 of second hollow cavity portion 20b is characterized as having yolk-entry aperture cross-sectional diameter 32, second cavity cross-sectional area 26b, and yolk-entry aperture cross-sectional area 34.

Proper sizing of yolk-retention aperture 40 is important to securely hold the egg yolk inside the apparatus. A yolk-retention aperture cross-sectional area that is too large may allow the yolk to slip out of the apparatus. A yolk-retention aperture cross-sectional area that is too small may increase probability of a damaging the egg yolk. Experimentation of various yolk-retention aperture configurations has shown that the preferred aperture cross-sectional areas for this aperture should fall within the range of about 0.20 sq. inch up to about 1.23 sq. inch for the apparatus to function optimally. In addition, circular to ellipsoidal shaped yolk-entry/retention aperture cross sectional areas are preferred. Configurations with these general shapes tend to minimize frictional and deformational forces as the yolk is drawn into the apparatus as these shapes mimic the natural cross-sectional shape of an egg yolk.

Proper sizing of the second cavity sidewall length 28b is also important for optimal performance of the egg separation task. As the yolk is drawn through the yolk-entry aperture 30 a shearing force is introduced between the egg yolk and egg white that aids in scraping away the unwanted egg white. While a properly sized entry aperture begins the shearing process, the length of the second hollow cavity sidewall 20b sustains the shearing force as the yolk travels toward the first hollow cavity portion 20a. A side wall length that is too short will cause the shearing force to be less effective in removing the egg white, while a sidewall length that is too long may increase the probability of yolk damage. Experimentation has shown that the preferred range for the second hollow cavity sidewall length 28b is the range of about 0.12 inches up to about 0.75 inches for the apparatus to function optimally.

Any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” in the claims herein is not intended to invoke the provisions of 35 U.S.C. Section 112, Paragraph 6.

The invention claimed is:

1. An apparatus for separating an egg yolk from a whole egg, the apparatus comprising:
a) a vacuum-producing means configured to produce a plurality of pressure levels comprising at least a first pressure level lower than the local ambient atmospheric pressure when operated, and comprising at least a second pressure level higher than the local ambient atmospheric pressure when operated;
b) a hollow cavity portion operatively coupled to said vacuum-producing means, the hollow cavity portion having:
i) a cavity volume at least large enough to hold one egg yolk;
ii) a yolk-entry aperture configured for drawing said egg yolk from outside of the apparatus into said hollow cavity when the vacuum-producing means is operated at said first pressure level.

2. The apparatus of claim 1 in which the yolk-entry aperture is further characterized as having a yolk-entry aperture cross-sectional area of at least about 0.20 square inches.

3. The apparatus of claim 1 in which the yolk-entry aperture is further characterized as having a yolk-entry aperture cross-sectional area of at most about 1.23 square inches.

4. The apparatus of claim 1 in which the yolk-entry aperture cross-sectional area is approximately circular in shape.

5. The apparatus of claim 1 in which the vacuum-producing means is manually operable.

6. The apparatus of claim 1 further characterized in that the hollow cavity portion has a cavity cross-sectional area and in that the yolk-entry aperture has a yolk-entry aperture cross-sectional area, and in that the cavity cross-sectional area and the yolk-entry aperture cross-sectional area are not equal in area.

7. The apparatus of claim 6 in which the yolk-entry aperture cross-sectional area is substantially equal to the cavity cross-sectional area.

8. The apparatus of claim 1 further characterized in that the hollow cavity portion has a cavity sidewall length of at least about 0.12 inches in length.

9. An apparatus for separating an egg yolk from a whole egg, the apparatus comprising:
a) a vacuum-producing means configured to produce a plurality of pressure levels comprising at least a first pressure level lower than the local ambient atmospheric pressure when operated, and comprising at least a second pressure level higher than the local ambient atmospheric pressure when operated;
b) a first hollow cavity portion operatively coupled to said vacuum-producing means, the first hollow cavity portion having:
i) a first cavity volume at least large enough to hold one egg yolk;
ii) a first hollow cavity cross-sectional area;
iii) a yolk-retention aperture having a yolk-retention aperture cross-sectional area that is smaller than said first hollow cavity cross-sectional area;
c) a second hollow cavity portion operatively coupled to said yolk-retention aperture, the second hollow cavity portion having:
i) a second cavity volume coupled to a yolk-entry aperture, the yolk-entry aperture configured for drawing said egg yolk from outside the apparatus through the second hollow cavity portion when said vacuum-producing means is operated at said first pressure level.

10. The apparatus of claim 9 in which the yolk-entry aperture is further characterized as having a yolk-entry aperture cross-sectional area of at least about 0.20 square inches.

11. The apparatus of claim 9 in which the yolk-entry aperture is further characterized as having a yolk-entry aperture cross-sectional area of at most about 1.23 square inches.

12. The apparatus of claim 9 in which the yolk-entry aperture has a cross-sectional area that is approximately circular in shape.

13. The apparatus of claim 9 in which the vacuum-producing means is manually operable.

14. The apparatus of claim 9 in which the yolk-retention aperture has a yolk-retention aperture cross-sectional area that is approximately circular in shape.

15. The apparatus of claim 9 further characterized in that the first hollow cavity portion has a first cavity cross-sectional area and in that the yolk-retention aperture has an yolk-retention aperture cross-sectional area, and that the first cavity cross-sectional area and the yolk-retention aperture cross-sectional area are not equal in size.

16. The apparatus of claim 15 in which the yolk-retention aperture cross-sectional area is smaller than the first hollow cavity cross-sectional area.

17. The apparatus of claim 9 further characterized in that the second hollow cavity portion has a second cavity sidewall length of at least about 0.12 inches in length and at most about 0.75 inches in length.

18. A method of separating an egg yolk from a whole egg, the whole egg comprising both egg yolk and egg white portions, the method comprising the steps of:
a) placing a yolk-entry aperture in contact with at least a portion of the egg yolk;
b) drawing said egg yolk through said yolk-entry aperture into a hollow cavity portion by the operation of a vacuum-producing means; and,
c) creating a shearing force between the egg yolk and the egg white by drawing said egg yolk through said hollow cavity portion.

19. The method of claim 18 further comprising the steps of:
a) drawing said egg yolk through a yolk-retention aperture by the operation of said vacuum-producing means; and,
b) holding said egg yolk proximate to said yolk-retention aperture.

20. The method of claim 18 further comprising the steps of: configuring the yolk-entry aperture to have a yolk-entry aperture cross-sectional area more than about 0.20 square inches; and, configuring the yolk-entry aperture to have a yolk-entry aperture cross-sectional area less than about 1.23 square inches.
